(19) United States
(12) Patent Application Publication
(10) Pub. No.: US 2026/0099023 A1
(43) Pub. Date: Apr. 9, 2026

(54) LC ADAPTER WITH INNER COVER

(71) Applicant: Huizhou Fibercan Industrial Co.,Ltd, Huizhou (CN)

(72) Inventors: Songsheng LI, Huizhou (CN); Jianchao CHEN, Huizhou (CN)

(21) Appl. No.: 19/308,746

(22) Filed: Aug. 25, 2025

(30) Foreign Application Priority Data
Oct. 9, 2024 (CN) 202411401467.7

(51) Int. Cl. G02B 6/44

(52) U.S. Cl. CPC G02B 6/4444

(57) ABSTRACT

An LC adapter with an inner cover is provided, which includes a frame sleeve and a grounding plate that is fastened to the frame sleeve. The frame sleeve is provided with a front insertion port, a rear insertion port, and a connection portion that connects the front insertion port and the rear insertion port. A plug is provided inside the connection portion, and a through-hole is provided at a bottom of the front insertion port. The grounding plate is fastened to the bottom of the front insertion port and covers the through hole. An elastic grounding structure that can abut against the grounding plate is provided at an opening of the front insertion port. When there is no external force, the elastic grounding structure blocks the opening of the front insertion port to prevent dust from entering the front insertion port and ensure signal transmission during good connection.

### CROSS-REFERENCE TO RELATED APPLICATIONS

This application claims priority to Chinese Patent Application No. 202411401467.7, filed on October 09, 2024, which is hereby incorporated by reference in its entirety.

### TECHNICAL FIELD

The present disclosure relates to the field of communications technology technologies, and in particular, to an LC adapter with an inner cover

### BACKGROUND

With the rapid development of technology, fiber optic adapters have been widely used in wired communication networks. When network connectors are not plugged into connector sockets, dust easily enters the sockets. Over time, excessive dust can easily affect the transmission quality of signals during connection. Besides that, the connectors have higher requirements for noise resistance, attenuation resistance, interference resistance, and dust prevention at high frequencies, and also have higher requirements for connection stability. Due to structural space limitations, most Lucent Connector, (LC) connectors do not have dust-proof sheets, or have dust-proof sheets but are assembled in a complex and unstable manner, or the dust-proof effect is unstable, and the service life is not long. This disclosure aims to solve the above problems.

### SUMMARY

In order to overcome the shortcomings of existing technology, the present disclosure provides an LC with an inner cover adapter.

The technical solution adopted by the present disclosure to solve its technical problem is: an LC adapter with an inner cover, including a frame sleeve, a grounding plate fastened to the frame sleeve, the frame sleeve is provided with a front insertion port, a rear insertion port, and a connection portion connecting the front insertion port and the rear insertion port, the connection portion is provided with a plug inside, a bottom of the front insertion port is provided with a through hole, the grounding plate is fastened to the bottom of the front insertion port and covers the through hole, an opening of the front insertion port is provided with an elastic grounding structure that abuts against the grounding plate.

In some embodiments of the present disclosure, a bottom of the opening of the front insertion port is provided with a frame strip connected to the through hole, the bottom of the front insertion port is provided with a concave step communicating with the through hole, the bottom of the front insertion port is provided with a rotating half socket and a positioning protrusion, the rotating half socket is provided on one side of the concave step, two inner walls of the front insertion port are provided with inclined steps.

In some embodiments of the present disclosure, the grounding plate covers an outer side of the through hole and is limited in the concave step, the elastic grounding structure includes an inner cover and an arc-shaped spring piece fixed between the inner cover and the grounding plate, the inner cover is hinged to the rotating half socket, and a head of the arc-shaped spring piece abuts against the inner cover; in a relaxed state, the inner cover is stopped by the inclined steps and covers an inner side of the front insertion port.

In some embodiments of the present disclosure, the inner cover includes an inner cover body, a rotating shaft fixedly connected to the inner cover body and protruding from two sides of the inner cover body, the inner cover body is tangent to an outer diameter of the rotating shaft, the rotating shaft is hinged to the rotating half socket, and a protruding arc portion facing an inner side of the front insertion port is provided on one side of the inner cover body close to the rotating shaft; the arc-shaped spring piece abuts against one side of the inner cover body facing the protruding arc portion.

In some embodiments of the present disclosure, the arc-shaped spring piece includes an arc-shaped body, a positioning piece fixedly connected to one end of the arc-shaped body, the arc-shaped body is provided with a frame-shaped gap, the positioning piece is provided with a positioning arc that communicates with the rotating half socket, the positioning arc is limited within the rotating half socket, the positioning arc is fixedly clamped between the grounding plate and the rotating shaft, the arc-shaped body includes an arc-shaped body tangent to the positioning piece, and the elastic contact part abuts against arc-shaped body; the elastic contact part abuts against the inner cover body, and an arc portion of the protruding arc portion that is protruding from the protruding arc portion is located in an inner ring area of the arc-shaped body.

In some embodiments of the present disclosure, the grounding plate includes a grounding plate body that is fastened to the frame sleeve, and a positioning part fixedly connected to the grounding plate body; the grounding plate body covers an outer side of the concave step, and the positioning part is provided with a clearance arc having the same curvature as the positioning arc; a bottom of the grounding plate body is provided with a positioning slot that engages with the positioning protrusion; the bottom of the grounding plate close to the positioning part is provided with a low-lying area.

In some embodiments of the present disclosure, the connection portion includes a separation plate arranged between the front insertion port and the rear insertion port and separating the front insertion port and the rear insertion port; the separation plate is provided with a front plug socket and a rear plug socket that penetrate through the separation plate and extend into the front insertion port and the rear insertion port, respectively; interiors of the front plug socket and the rear plug socket are both hollow and communicated, the rear plug socket is hollow cylindrical, the plug is provided into the front plug socket and the rear plug socket, and a side wall of the rear plug socket is provided with a notch.

The beneficial effect of the present disclosure is to provide an LC inner cover adapter, the inner cover and arc-shaped spring piece are assembled into the frame sleeve, and then the grounding piece is fastened to the frame sleeve to fix the inner cover and arc-shaped spring piece. The assembly is simple, and the structure is stable. The grounding plate is fastened to the frame sleeve, and the grounding plate covers the through hole, so the grounding plate does not occupy space outside the frame sleeve, thereby achieving the purpose of effectively utilizing space. The elastic grounding structure blocks the opening of the front insertion port when there is no external force, preventing dust from entering the front insertion port and ensuring good signal transmission quality during connection. Due to the relatively large inner diameter of the arc-shaped body, the arc portion protruding from the protruding arc portion is located within the inner ring area of the arc-shaped body, thereby providing greater accommodation space for the protruding arc portion. The protruding portion of the protruding arc portion avoids touching the arc-shaped spring piece or grounding plate in any state, thereby reducing the probability of damage to the arc-shaped spring piece or grounding plate and increasing the service life of the arc-shaped spring piece, grounding plate, and the entire adapter.

The providing the notch facilitates the opening of the hollow cylinder of the rear plug socket, increases its diameter, and facilitates the installation of the plug. After the plug is assembled, the notch of the rear plug socket returns to its original shape when the plug socket is released, and the diameter decreases and returns to its original diameter, thereby ensuring the stability of the plug installation in the front plug socket and the rear plug socket.

The present disclosure has a simple and compact structure and is easy to install.

### BRIEF DESCRIPTION OF DRAWINGS

FIG. 1 is a schematic structural diagram of an LC adapter with an inner cover according to the present disclosure.

FIG. 2 is a schematic diagram of an exploded structure of the LC adapter with an inner cover according to the present disclosure.

FIG. 3 is a schematic structural diagram of a frame sleeve of the LC adapter with an inner cover according to the present disclosure.

FIG. 4 is a schematic structural diagram of an inner cover of the LC adapter with an inner cover according to the present disclosure.

FIG. 5 is a schematic structural diagram of an arc-shaped spring piece of the LC adapter with an inner cover of the present disclosure.

FIG. 6 is a schematic diagram of a front structure of a grounding plate of the LC adapter with an inner cover of the present disclosure.

FIG. 7 is a schematic diagram of a front structure of a frame sleeve of the LC adapter with an inner cover according to the present disclosure.

FIG. 8 is a schematic diagram of a A-A cross-sectional structure of FIG. 7.

FIG. 9 is a schematic diagram of a frame sleeve of the LC adapter with an inner cover in another direction of the present disclosure.

FIGS. 10 and 11 are schematic diagrams of two different implementation effects of the LC adapter with an inner cover according to the present disclosure.

### DESCRIPTION OF EMBODIMENTS

The embodiments of the present disclosure will be described below in combination with the accompanying drawings and relevant embodiments. The embodiments of the present disclosure are not limited to the following embodiments, and the present disclosure relates to necessary components in this technical field, which should be regarded as well-known technology in this technical field and can be known and mastered by those skilled in the art.

In the description of the present disclosure, it should be noted that terms “up”, “down”, “inside”, “outside”, etc. indicate orientation or positional relationships based on the orientation or positional relationships shown in the accompanying drawings, or the orientation or positional relationships commonly used when using the product of the present disclosure. This is only for a convenience of describing the present disclosure and simplifying the description, and does not indicate or imply that the device or component referred to must have a specific orientation, be constructed and operated in a specific orientation, and therefore cannot be understood as a limitation of the present disclosure. Besides that, terms “first”, “second”, etc. are only used to distinguish descriptions and cannot be understood as indicating or implying relative importance. In the description of the present disclosure, it should be noted that unless otherwise specified and limited, terms “providing” and “connection” should be broadly understood, for example, it can be a fixed connection, a detachable connection, or an integrated connection; it can be a mechanical connection or an electrical connection; it can be directly connected, indirectly connected through an intermediate medium, or connected internally between two components. For those skilled in the art, specific meanings of the above terms in the present disclosure can be understood in specific situations.

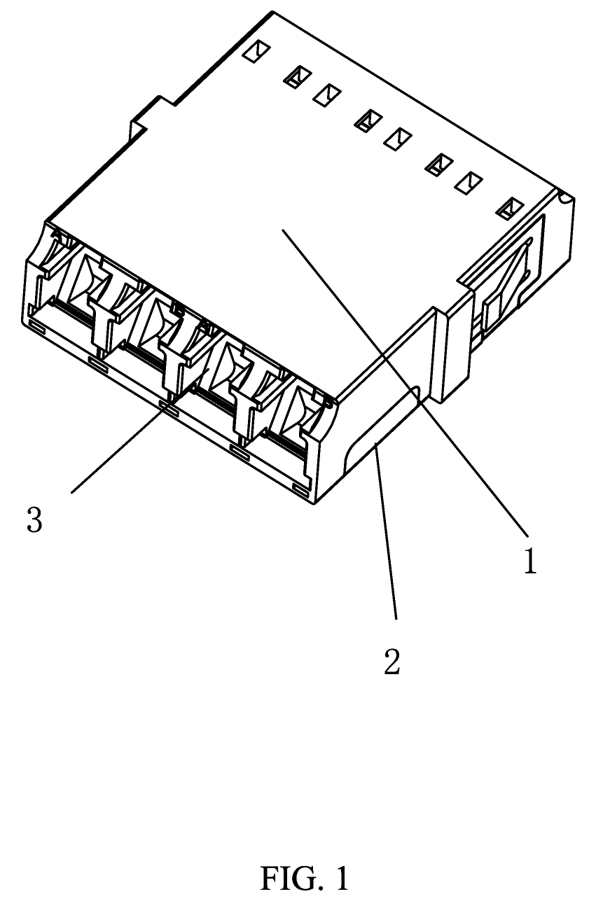

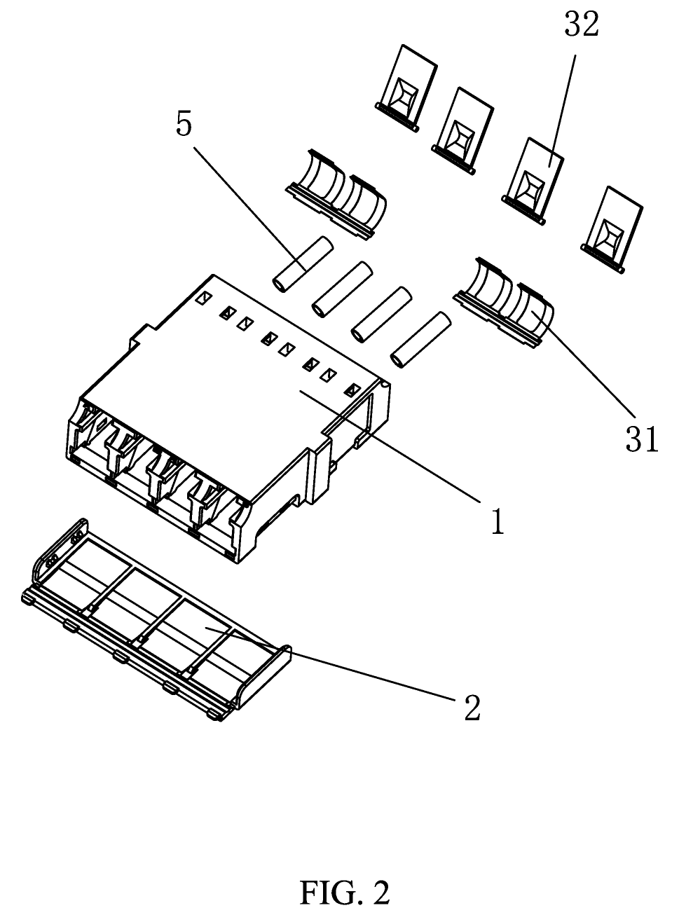

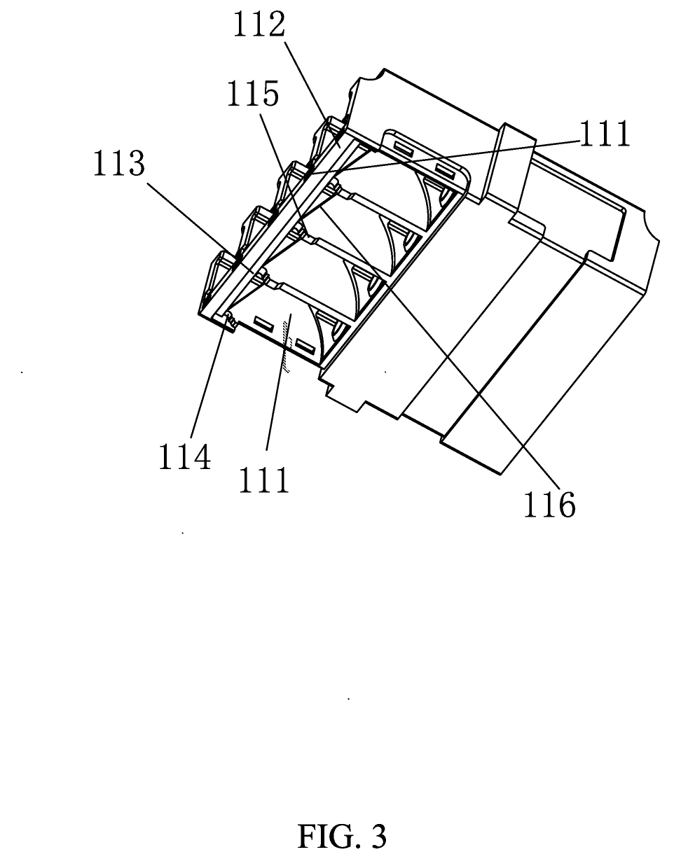

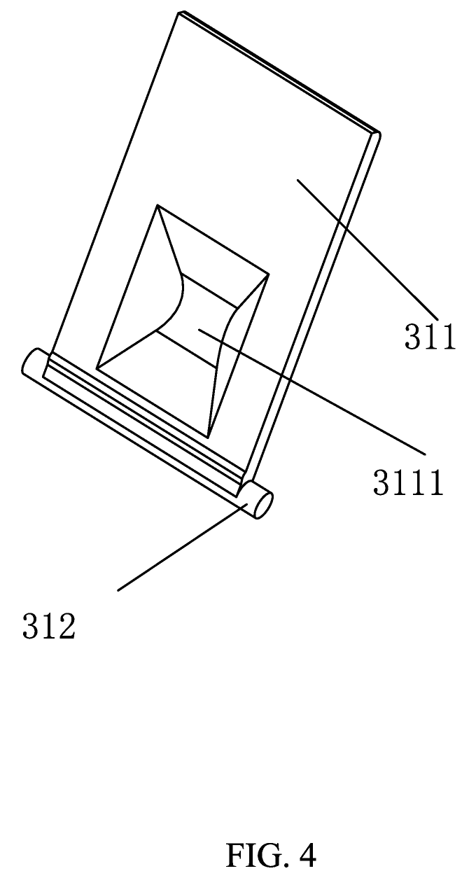

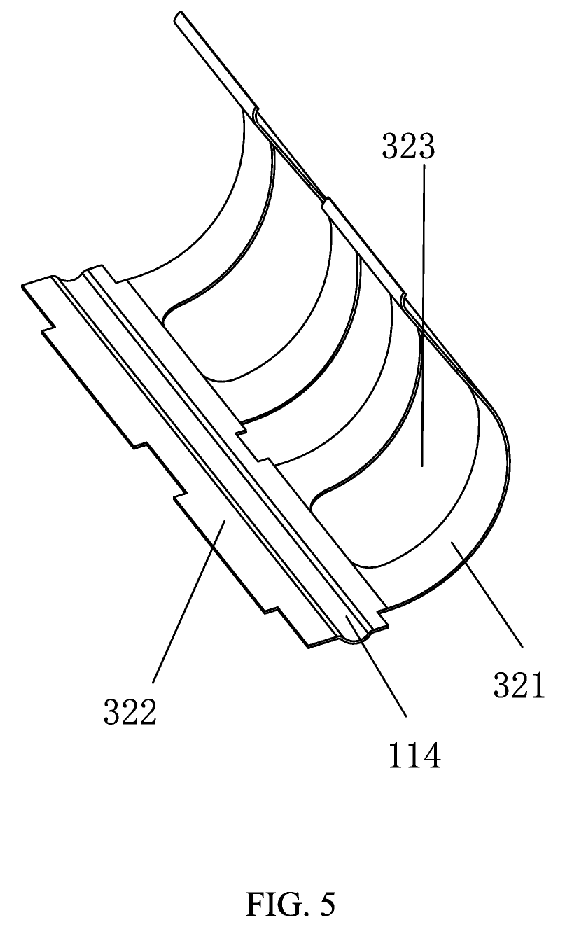

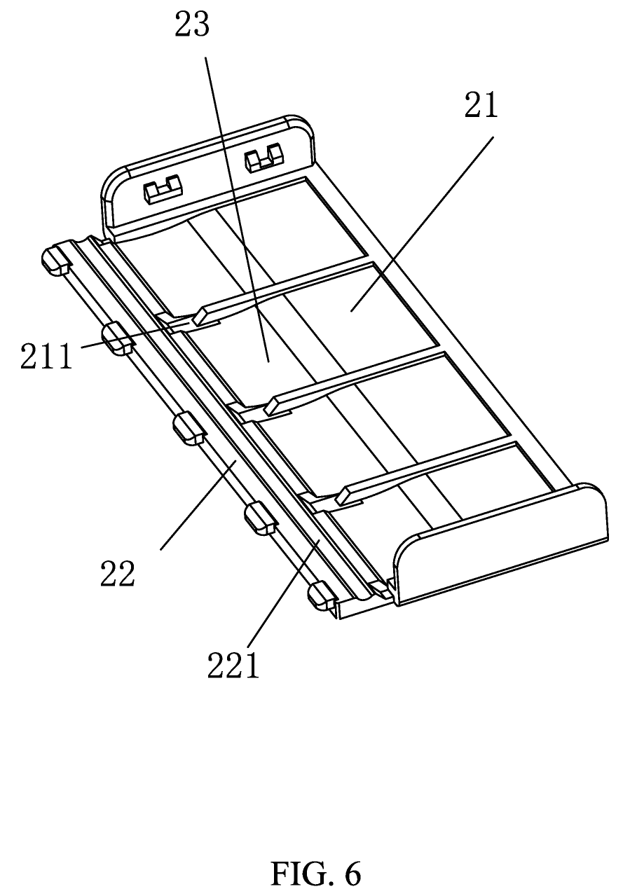

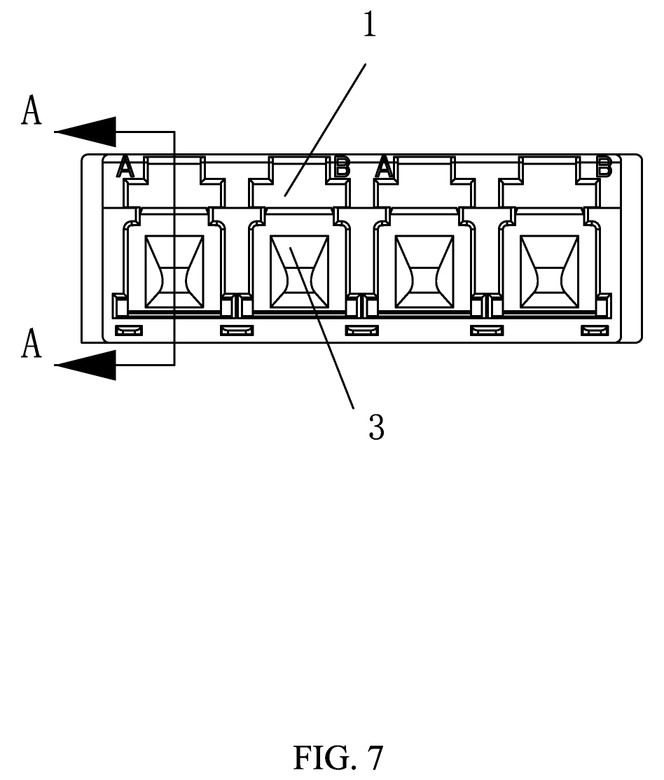

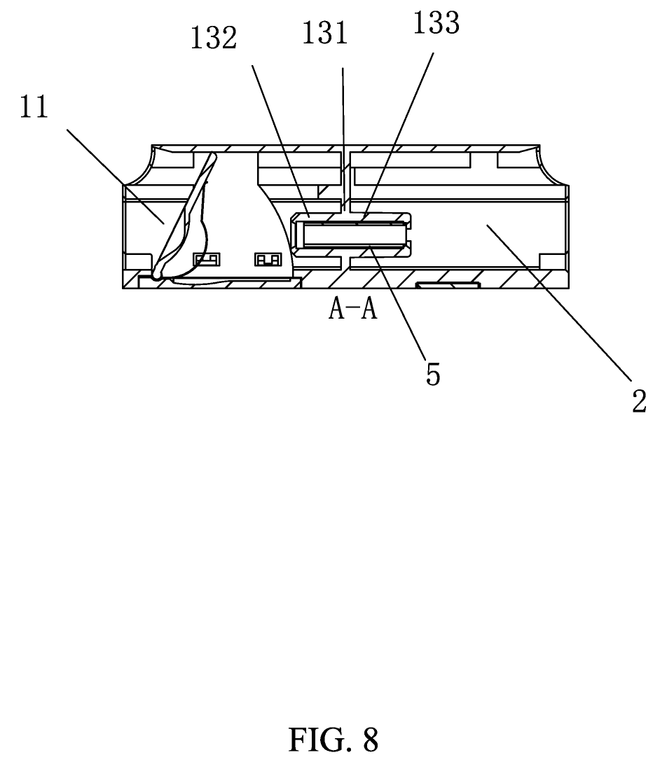

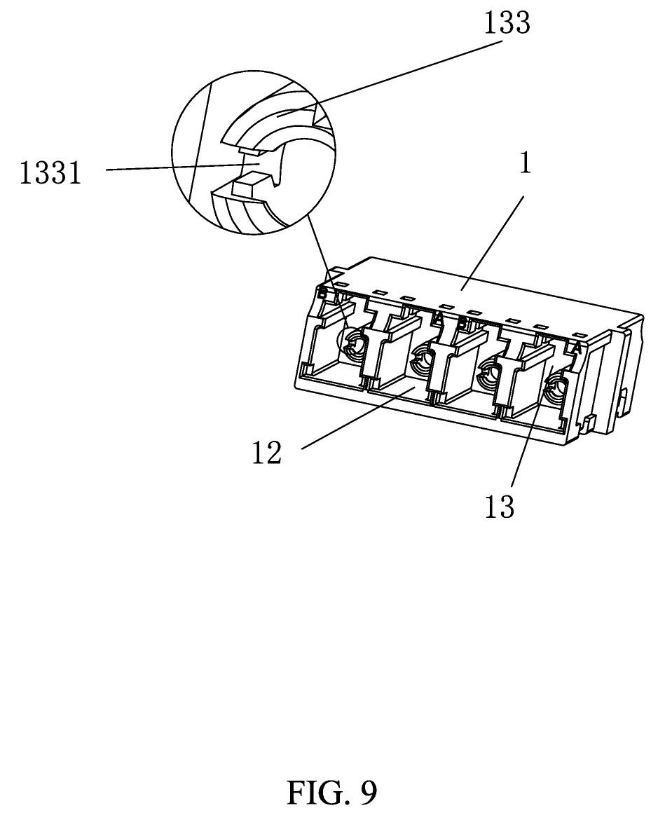

Referring to FIGS. 1 to 9, the present disclosure is implemented as follows: an LC adapter with an inner cover, including a frame sleeve 1, a grounding plate 2 fastened to the frame sleeve 1, the frame sleeve 1 is provided with a front insertion port 11, a rear insertion port 12, and a connection portion 13 connecting the front insertion port 11 and the rear insertion port 12, a plug 5 is provided inside the connection portion 13, and a through hole 111 is provided at a bottom of the front insertion port 11. The grounding plate 2 is fastened to the bottom of the front insertion port 11 and covers the through hole 111, and an elastic grounding structure 3 that contacts the grounding plate 2 is provided at an opening of the front insertion port 11.

In this embodiment, the grounding plate 2 is fastened to the frame sleeve 1, and the grounding plate 2 covers the through hole 111, so the grounding plate 2 does not occupy the space outside the frame sleeve 1, thereby achieving the purpose of effectively utilizing space. When there is no external force acting, the elastic grounding structure 3 blocks the opening of the front insertion port 11, preventing dust from entering the front insertion port 11 and ensuring good signal transmission quality during connection.

In an implementation mode, the front insertion port 11 is provided with a frame strip 112 connected to the through hole 111 at a bottom of the opening, and a concave step 113 communicated to the through hole 111 at the bottom of the front insertion port 11. The concave step 113 partially extends to the frame strip 112, and the bottom of the front insertion port 11 is provided with a rotating half socket 114 and a positioning protrusion 115. The rotating half socket 114 is provided on one side of the concave step 113, and two inner walls of the front insertion port 11 are provided with inclined step 116. When there is no external plug connection, the elastic grounding structure 3 prevents dust from entering the front insertion port 11.

The grounding plate 2 covers an outer side of the through hole 111 and is limited within the concave step 113. The elastic grounding structure 3 includes an inner cover 31 and an arc-shaped spring piece 32 fixed between the inner cover 31 and the grounding plate 2. The inner cover 31 is hinged to the rotating half socket 114, and a head of the arc-shaped spring piece 32 abuts against the inner cover 31. In a relaxed state, the inner cover 31 is stopped by the inclined step 116 and covers an inner side of the front insertion port 11.

The inner cover 31 includes an inner cover body 311 and a rotating shaft 312 fixedly connected to the inner cover body 311 and protruding from two sides of the inner cover body 311. The inner cover body 311 is tangent to an outer diameter of the rotating shaft 312, and the rotating shaft 312 is hinged to the rotating half socket 114. The inner cover body 311 is provided with a protruding arc portion 3111 facing an inner side of the front insertion port 11 on one side near the rotating shaft 312. The arc-shaped spring piece 32 abuts against one side of the inner cover body 311 facing the protruding arc portion 3111. The arc-shaped spring piece 32 includes an arc-shaped body 321 and a positioning piece 322 fixedly connected to one end of the arc-shaped body 321. The arc-shaped body 321 is provided with a frame-shaped gap 323, and the positioning piece 322 is provided with a positioning arc 324 having the same curvature as the positioning arc communicated to the rotating half socket 114. The positioning arc 324 is limited within the rotating half socket 114, and is fixedly clamped between the grounding plate 2 and the rotating shaft 312. The arc-shaped body 321 includes an arc-shaped body 3211 that is tangent to the positioning piece 322, and an elastic contact part 3212 that is connected to the arc-shaped body 3211. The elastic contact part 3212 abuts against the inner cover body 311, and an arc portion of the protruding arc-shaped portion 3111 is located in an inner ring area of the arc-shaped body 3211.

The grounding plate 2 includes a grounding plate body 21 that is fastened to the frame sleeve 1, and a positioning part 22 that is fixedly connected to the grounding plate body 21. The grounding plate body 21 covers an outer side of the concave step 113, and the positioning part 22 is provided with a clearance arc 221 that has the same curvature as the positioning arc 324.. A bottom of the grounding plate body 21 is provided with a positioning slot 211 that engages with the positioning protrusion 115, and the bottom of the grounding plate 2 is provided with a low-lying area 23 close to the positioning portion 22.

During installation, the inner cover 31, arc-shaped spring piece 32, and grounding plate 2 are assembled in sequence. The rotating shaft 312 of the inner cover 31 is hinged to the positioning arc 324, and the positioning arc 324 is in contact with the clearance arc 221. The elastic grounding plate 2 is provided on a lower side of the inner cover 31, and the inner cover body 311 is stopped by the inclined step 116 and covers an inner side of the front insertion port 11. The positioning piece 322 of the arc-shaped spring piece 32 covers a part of the concave step 113 in the frame strip 112, and the positioning arc 324 covers the outer side of the rotating shaft 312 of the inner cover 31. When the rotating shaft 312 rotates and works, the rotating shaft 312 is between the inner cover 31 and the grounding plate 2. After the grounding plate 2 is assembled, the grounding plate 2 and the inner cover 31 confine the arc-shaped spring piece 32 within it. The entire assembly is simple and convenient, with low damage rate of parts due to installation, saving production costs, and the overall structure is stable after assembly.

When the external plug is inserted from the front insertion port 11, the external plug interferes with the inner cover 31 and rotates around the rotating shaft 312, thereby pushing the arc-shaped spring piece 32 to rotate around the positioning piece 322 until the arc-shaped body 321 of the arc-shaped spring piece 32 contacts the low-lying area 23. The inner cover body 311 is tangent to an outer diameter of the rotating shaft 312, which facilitates the smooth pushing of the external plug on the inner cover 31. The arc-shaped body 3211 is tangent to the positioning piece 322 and connected to the elastic contact part 3212. When the inner cover 31 is pushed by the external plug and the arc-shaped spring piece 32 tilts towards the grounding plate 2, due to the relatively large inner diameter of the arc-shaped body 3211, the arc portion of the protruding arc portion 3111 is located on the inner ring of the arc-shaped body 3211. In the area, a larger accommodation space is provided for the protruding arc portion 3111, and a protruding part of the protruding arc portion 3111 avoids touching the arc-shaped spring piece 32 or the grounding plate 2 in any state, thereby reducing the probability of damage to the arc-shaped spring piece 32 or the grounding plate 2, and increasing the service life of the arc-shaped spring piece 32, the grounding plate 2, and the entire embodiment adapter.

When the external side is inserted and removed from the front insertion port 11, the arc-shaped body 3211 provides sufficient rebound force to reset the inner cover 31 and the arc-shaped spring piece 32 to a start state, so that the inner cover 31 blocks the front insertion port 11 to achieve the purpose of dust prevention.

The inner cover 31 and the arc-shaped spring piece 32 are both made of conductive materials. The external plug abuts against the inner cover 31 and the arc-shaped spring piece 32, and then in conductive contact with the grounding plate 2, thus achieving the purpose of grounding.

When there is no external plug connection, the inner cover 31 is pushed forward by the head of the arc-shaped spring piece 32 towards the opening of the front insertion port 11 until the inclined step 116 stops the inner cover 31, preventing dust from entering the front insertion port 11.

In an implementation mode, the connection portion 13 includes a separation plate 131 arranged between the front insertion port 11 and the rear insertion port 12 and separating the front insertion port 11 and the rear insertion port 12. The separation plate 131 is provided with a front plug socket 132 and a rear plug socket 133 that penetrate through it and extend into the front insertion port 11 and the rear insertion port 12 at two ends, respectively. Interiors of the front plug socket t 132 and the rear plug socket 133 are both hollow and communicated, and the rear plug socket 133 is configured to be a hollow cylinder. The plug 5 is provided into the front plug socket 132 and the rear plug socket t 133, and one side of the rear plug socket 133 is provided with a notch 1331.

Providing the notch 1331 facilitates the opening of the hollow cylinder of the rear plug socket 133, increases its diameter, and facilitates the installation of the plug 5. After the plug 5 is installed, the notch 1331 of the rear plug socket 133 returns to its original shape, and the diameter decreases back to its original diameter, ensuring the stability of the installation of the plug 5 in the front plug socket 132 and the rear plug socket 133.

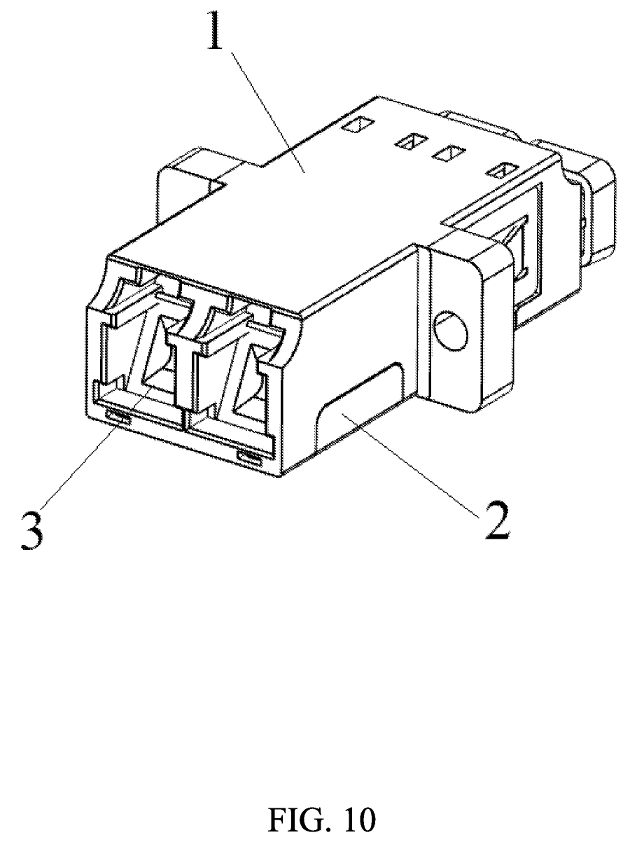

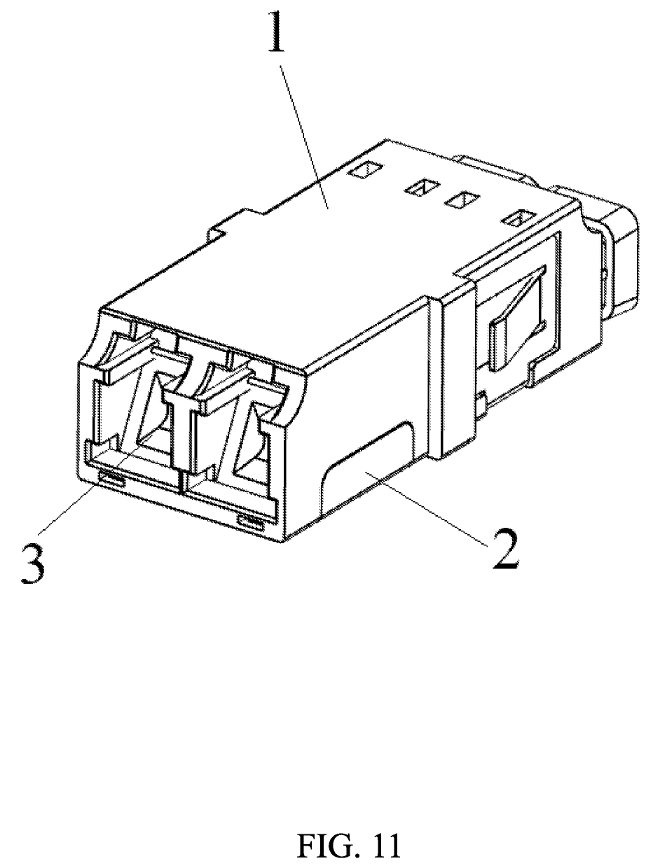

As shown in FIGS. 1, 10, and 11, it should be noted that the embodiment of the present disclosure adopts four links as the implementation explanation. In fact, the present disclosure can be made into any number of links with the same structure, such as single links, double links, triple links, etc. For example, both FIGS. 10 and 11 are double link effect diagrams, and FIG. 10 shows that the frame sleeve 1 of the LC adapter with an inner cover of the present disclosure has through holes on two sides of the protrusions, which can facilitate auxiliary positioning during assembly and connection.

The preferred embodiments of the present disclosure should be noted that those skilled in the art may make several improvements and embellishments without departing from the principles of the present disclosure, and these improvements and embellishments should also be considered within the protection scope of the present disclosure.

What is claimed is:

1. An LC adapter with an inner cover, comprising a frame sleeve, a grounding plate fastened to the frame sleeve,
the frame sleeve is provided with a front insertion port, a rear insertion port, and a connection portion connecting the front insertion port and the rear insertion port,
the connection portion is provided with a plug inside, a bottom of the front insertion port is provided with a through hole, the grounding plate is fastened to the bottom of the front insertion port and covers the through hole,
an opening of the front insertion port is provided with an elastic grounding structure that abuts against the grounding plate.

2. The LC adapter with an inner cover according to claim 1, wherein a bottom of the opening of the front insertion port is provided with a frame strip connected to the through hole,
the bottom of the front insertion port is provided with a concave step communicating with the through hole,
the bottom of the front insertion port is provided with a rotating half socket and a positioning protrusion,
the rotating half socket is provided on one side of the concave step,
two inner walls of the front insertion port are provided with inclined steps.

3. The LC adapter with an inner cover according to claim 2, wherein the grounding plate covers an outer side of the through hole and is limited in the concave step,
the elastic grounding structure comprises an inner cover and an arc-shaped spring piece fixed between the inner cover and the grounding plate,
the inner cover is hinged to the rotating half socket, and a head of the arc-shaped spring piece abuts against the inner cover;
in a relaxed state, the inner cover is stopped by the inclined steps and covers an inner side of the front insertion port.

4. The LC adapter with an inner cover according to claim 3, wherein the inner cover comprises an inner cover body, a rotating shaft fixedly connected to the inner cover body and protruding from two sides of the inner cover body,
the inner cover body is tangent to an outer diameter of the rotating shaft,
the rotating shaft is hinged to the rotating half socket, and a protruding arc portion facing an inner side of the front insertion port is provided on one side of the inner cover body close to the rotating shaft;
the arc-shaped spring piece abuts against one side of the inner cover body facing the protruding arc portion.

5. The LC adapter with an inner cover according to claim 4, wherein the arc-shaped spring piece comprises an arc-shaped body, a positioning piece fixedly connected to one end of the arc-shaped body,
the arc-shaped body is provided with a frame-shaped gap, the positioning piece is provided with a positioning arc that communicates with the rotating half socket,
the positioning arc is limited within the rotating half socket,
the positioning arc is fixedly clamped between the grounding plate and the rotating shaft,
the arc-shaped body comprises an arc-shaped body tangent to the positioning piece, and the elastic contact part abuts against arc-shaped body;
the elastic contact part abuts against the inner cover body, and an arc portion of the protruding arc portion that is protruding from the protruding arc portion is located in an inner ring area of the arc-shaped body.

6. The LC adapter with an inner cover according to claim 3, wherein the grounding plate comprises a grounding plate body that is fastened to the frame sleeve, and a positioning part fixedly connected to the grounding plate body;
the grounding plate body covers an outer side of the concave step, and the positioning part is provided with a clearance arc having the same curvature as the positioning arc;
a bottom of the grounding plate body is provided with a positioning slot that engages with the positioning protrusion;
the bottom of the grounding plate close to the positioning part is provided with a low-lying area.

7. The LC adapter with an inner cover according to claim 1, wherein the connection portion comprises a separation plate arranged between the front insertion port and the rear insertion port and separating the front insertion port and the rear insertion port;
the separation plate is provided with a front plug socket and a rear plug socket that penetrate through the separation plate and extend into the front insertion port and the rear insertion port, respectively;
interiors of the front plug socket and the rear plug socket are both hollow and communicated,
the rear plug socket is hollow cylindrical,
the plug is provided into the front plug socket and the rear plug socket, and a side wall of the rear plug socket is provided with a notch.
